(19) United States
(12) Patent Application Publication
(10) Pub. No.: US 2019/0199751 A1
(43) Pub. Date: Jun. 27, 2019

(54) Shadow IT Discovery Using Traffic Signatures

(71) Applicant: Forcepoint, LLC, Austin, TX (US)

(72) Inventors: Alex Lipman, Rehovot (IL); Ofer Yarom, Raanana (IL)

(21) Appl. No.: 15/850,524

(22) Filed: Dec. 21, 2017

(51) Int. Cl. H04L 29/06; H04L 29/08

(52) U.S. Cl. CPC H04L 63/20; H04L 67/16; H04L 63/10; H04L 67/42; H04L 63/1425; H04L 63/1416; H04L 67/02; H04L 63/0281

(57) ABSTRACT

A method, system and computer-usable medium for performing a shadow information technology discover operation, comprising: monitoring interactions initiated via an endpoint device; determining when the interactions comprise a cloud services request, the cloud services request comprising a request by a user to access a cloud service; monitoring interactions between the user and the cloud service when a request to access the cloud service is detected; determining whether the interactions between the user and the cloud service represent a non-authorized use of the cloud service; and, managing risk associated with non-authorized use of the cloud service.

### BACKGROUND OF THE INVENTION

### Field of the Invention

The present invention relates in general to the field of computers and similar technologies, and in particular to software utilized in this field. Still more particularly, it relates to a method, system and computer-usable medium for managing risk associated with non-authorized use of a cloud-based service.

### Description of the Related Art

Users interact with physical, system, data, and services resources of all kinds, as well as each other, on a daily basis. Each of these interactions, whether accidental or intended, poses some degree of security risk. However, physical and cyber security efforts have traditionally been oriented towards preventing or circumventing the intent of external threats.

More particularly, physical security approaches have typically focused on monitoring and restricting access to tangible resources. Likewise, cyber security approaches have included network access controls, intrusion detection and prevention systems, machine learning, big data analysis, software patch management, and secured routers. Accordingly, such approaches are generally more oriented to security administration than risk adaptation. As a result, the traditional focus of physical and cyber security has been on enforcing policies for compliance, privacy, and the protection of intellectual property (IP).

However, not all user behavior poses the same risk. For example, unauthorized use of a cloud-based service for business purposes may pose a higher risk to an organization than authorized use of the same cloud-base service for the same or similar business purposes. Likewise, use of a cloud-based service for personal purposes may pose a lower risk to an organization than authorized, or unauthorized, use of the same cloud-based service for business purposes. Consequently, applying the same policy to all user behavior instead of adaptively adjusting security oversight according to the intended use of a particular cloud-based service may result in a sub-optimal security response.

### SUMMARY OF THE INVENTION

A method, system and computer-usable medium are disclosed for managing risk associated with non-authorized use of a cloud-based service. In certain embodiments, the invention relates to a method, system and computer-usable medium for performing a shadow information technology discover operation, comprising: monitoring interactions initiated via an endpoint device; determining when the interactions comprise a cloud services request, the cloud services request comprising a request by a user to access a cloud service; monitoring interactions between the user and the cloud service when a request to access the cloud service is detected; determining whether the interactions between the user and the cloud service represent a non-authorized use of the cloud service; and, managing risk associated with non-authorized use of the cloud service.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an endpoint agent;

FIG. 3 is a simplified block diagram of the operation of a shadow IT discovery system 2;

FIG. 4 is a simplified block diagram of the operation of a shadow IT discovery security system; and

FIGS. 5a through 5b are a generalized flowchart of the performance of shadow IT discovery security operations.

### DETAILED DESCRIPTION

A method, system and computer-usable medium are disclosed for managing risk associated with non-authorized use of a cloud-based service. Certain aspects of the invention reflect an appreciation that the implementation and use of certain information technology (IT) systems and services inside an organization without explicit organizational authorization may result in the incurrence of associated risk. Likewise, certain aspects of the invention reflect an appreciation that such “shadow IT” or “stealth IT” activity may refer to systems, services and data developed, implemented and used without the explicit knowledge of an organization's IT department. Certain aspects of the invention likewise reflect an appreciation that shadow IT or shadow IT activities may include authorized use of various systems, services and data for unauthorized purposes.

Certain aspects of the invention reflect an appreciation that analysis of proxy traffic logs is one known approach to detecting access to cloud-based software services, often referred to as Software as a Service (SaaS). In particular, certain known Cloud-Access Security Broker (CASB) approaches process proxy traffic logs to generate reports indicating which users accessed which cloud-based services at what time. Likewise, certain aspects of the invention reflect an appreciation that such CASB approaches may be implemented to provide security, management or both.

As used herein, in the context of a CASB, “security” broadly refers to the prevention of a risk event, while “management” broadly refers to the mitigation of risk after the occurrence of a risk event. As an example, a typical CASB may be implemented to compare the Uniform Resource Locator (URL) address in a Hypertext Transfer Protocol (HTTP) request to a list of restricted addresses. If there is a match, the HTTP request may not be allowed to proceed. In this example, the CASB is implemented to provide security. As another example, a notification may be provided to a security administrator if such a match occurs. In this example, the CASB is implemented to provide management.

Certain aspects of the invention reflect an appreciation that a CASB may be implemented on-premises, or as a cloud-based service, to monitor interactions between users and various cloud services. Likewise, certain aspects of the invention reflect an appreciation that information associated with of such monitored interactions may be used to enforce various security policies. Certain aspects of the invention likewise reflect an appreciation that a CASB may be implemented to provide a variety of security services. Such services may include monitoring certain actions of a particular user, providing an alert to a security administrator related to certain user actions that may be potentially hazardous, enforcing compliance with certain security policies, and taking automatic actions to reduce risk.

However, certain aspects of the invention may likewise reflect an appreciation that typical CASB approaches to identifying access of a particular cloud-based service are unable to determine whether such an access was for authorized or unauthorized purposes. Likewise, certain aspects of the invention may reflect an appreciation that typical CASB approaches are unable to determine whether a user has used a cloud-based service to enact risky behavior that may pose a risk to confidentiality, integrity, or availability of an organization's proprietary information. Furthermore, certain aspects of the invention may reflect an appreciation that the legitimate use of a cloud-based service for personal purposes may result in a CASB generating a false positive alert related to possible shadow IT activity.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a mobile device such as a tablet or smartphone, a connected “smart device,” a network appliance, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more storage systems, one or more network ports for communicating externally, as well as various input and output (I/O) devices, such as a keyboard, a mouse, and a graphics display.

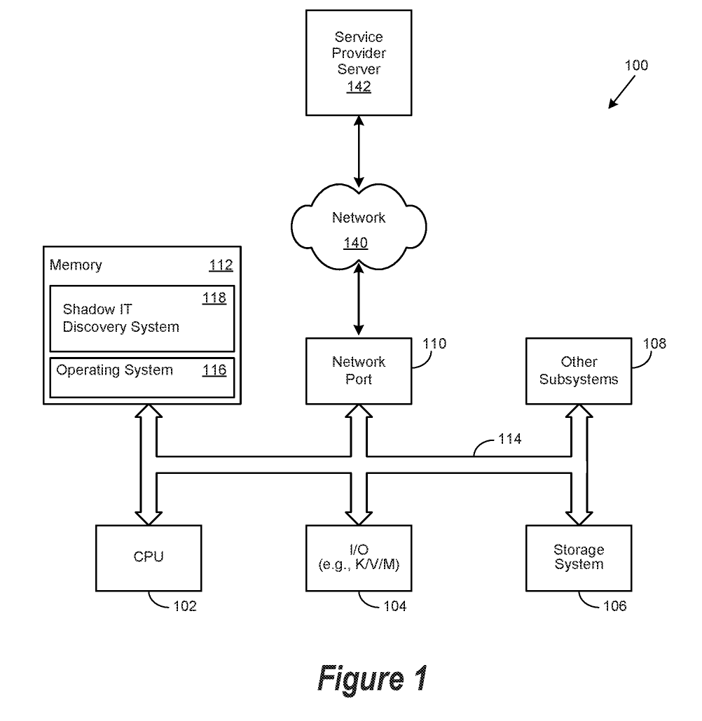

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a storage system 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further includes operating system (OS) 116 and in various embodiments may also include a shadow IT discovery system 118. In one embodiment, the information handling system 100 is able to download the shadow IT discovery system 118 from the service provider server 142. In another embodiment, the shadow IT discovery system 118 is provided as a service from the service provider server 142.

In various embodiments, the shadow information technology (IT) discovery system 118 performs a shadow IT discovery operation, described in greater detail herein. In certain embodiments, the shadow IT discovery operation improves processor efficiency, and thus the efficiency of the information handling system 100, by the discovering the performance of shadow IT operations. As will be appreciated, once the information handling system 100 is configured to perform the shadow IT discovery operation, the information handling system 100 becomes a specialized computing device specifically configured to perform the shadow IT discovery operation and is not a general purpose computing device. Moreover, the implementation of the shadow IT discovery system 118 on the information handling system 100 improves the functionality of the information handling system 100 and provides a useful and concrete result of discovering the performance of shadow IT operations.

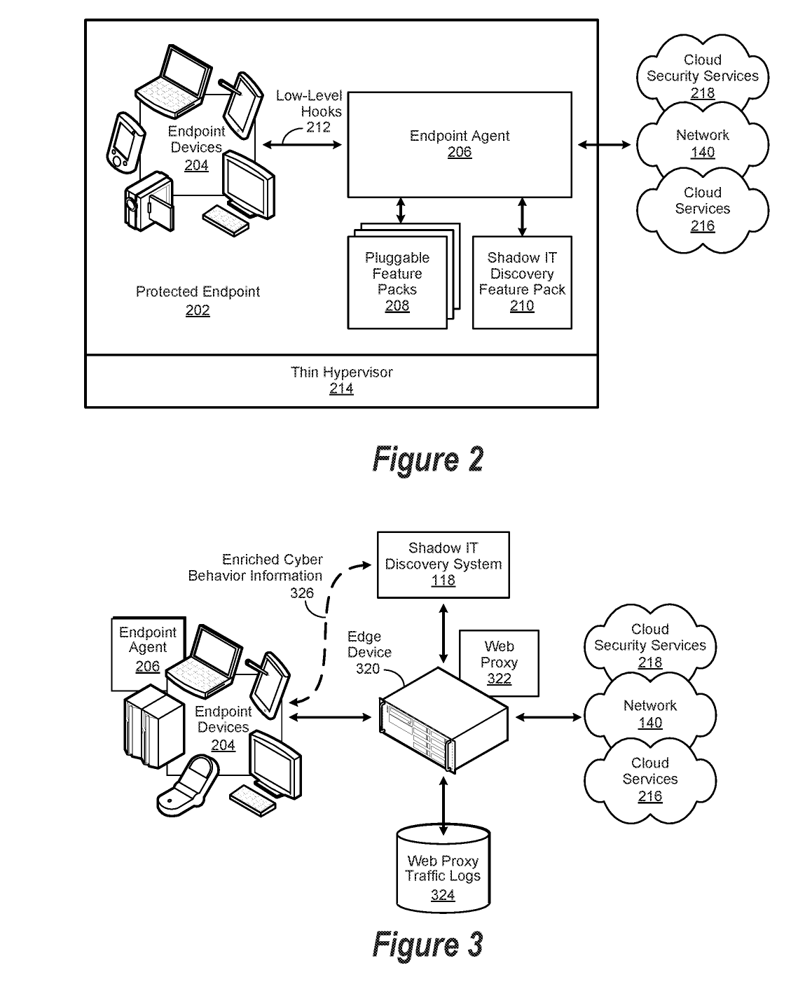

FIG. 2 is a simplified block diagram of an endpoint agent implemented in accordance with an embodiment of the invention. As used herein, an endpoint agent 206 broadly refers to a software agent used in combination with an endpoint device 204 to establish a protected endpoint 202. Skilled practitioners of the art will be familiar with software agents, which are computer programs that perform actions on behalf of a user or another program. In various approaches, a software agent may be autonomous or work together with another agent or a user. In certain of these approaches the software agent is implemented to autonomously decide whether a particular action is appropriate for a given event. In certain embodiments, such an event may include the occurrence of a shadow information technology (IT) operation, electronically-observable user behavior, or a combination thereof.

As used herein, shadow IT, also known as stealth IT, broadly refers to the implementation and use of certain systems, services, operations, processes, and data, or a combination thereof, inside an organization without explicit organizational authorization. In certain embodiments, such explicit organizational authorization may be granted by an organization's management, their IT department, their security department, or a combination thereof. As likewise used herein, a shadow IT discovery operation broadly refers to any action performed by a system, device, process, user, or combination thereof, to detect shadow IT activity, as described in greater detail herein. In certain embodiments, such shadow IT activities may likewise be performed by a user, a process, a device, a system, or a combination thereof.

Electronically-observable user behavior, as used herein, broadly refers to any behavior exhibited or enacted by a user that can be detected through the implementation of an electronic device, a system, a network, or a combination thereof. In certain embodiments, the electronically-observable user behavior may include cyber behavior. Likewise, as used herein, cyber behavior broadly refers to any behavior occurring in cyberspace, whether enacted by an individual user, a group of users, an entity, or a system acting at the behest of an individual user, a group of users, or an entity.

More particularly, cyber behavior may include physical, social, or mental actions that can be objectively observed, or indirectly inferred, within cyberspace. As an example, a user may use an endpoint device 204 to access a particular cloud service 216 via a network 140. In this example, the individual actions performed by the user to access the cloud service 216 via the network 140 may constitute one or more cyber behaviors. Furthermore, since the actions are enacted within cyberspace, they become electronically-observable.

Cyberspace, as likewise used herein, broadly refers to a network 140 environment capable of supporting communication between two or more entities. In various embodiments, the entity may be a user, an endpoint device 204, a system, or various resources described in greater detail herein. In certain embodiments, the entities may include various endpoint devices 204, systems or resources operating at the behest of an entity, such as a user, a group, or an organization. In various embodiments, the communication between the entities may include audio, image, video, text, or binary data.

As likewise used herein, an endpoint device 204 broadly refers to an information processing system such as a personal computer, a laptop computer, a tablet computer, a personal digital assistant (PDA), a smart phone, a mobile telephone, a digital camera, a video camera, or other device capable of storing, processing and communicating data. In certain embodiments, the data may be communicated through the use of a network 140. In certain embodiments, the communication of the data may take place in real-time or near-real-time.

As used herein, a cloud-based service, also commonly referred to as a cloud service 216, broadly refers to the provision of certain computing resources on a service-oriented basis within a network 140 environment, such as the Internet. In certain embodiments, the computing resource may include computer networks, servers, storage, applications, computing program components, processes, functions, and data, or a combination thereof. Examples of such services include Infrastructure as a Service (IaaS), Platform as a Service (PaaS), Software as a Service (SaaS), Security as a Service (SECaaS), Mobile “back-end” as a Service (MBaaS), and serverless computing, all of which are familiar to skilled practitioners of the art.

In certain embodiments, shadow IT discovery operations may include detection of cyber behavior associated with accessing a particular cloud service 216. In certain embodiments, the cyber behavior may include various cyber behavior factors associated with accessing a cloud service 216. In certain embodiments, the cyber behavior factors may include identification or authentication factors associated with a user, the role or access rights of a user, other information associated with a user, or some combination thereof. As an example, such cyber behavior factors may include the user's log-in information (e.g., UserID and password), authentication information associated with the user (e.g., private and public keys, digital certificates, etc.), their role (e.g., sales administrator), their associated access rights (e.g., sales forecasts).

In certain embodiments, the cyber behavior may likewise include information associated with a user submitting an HTTP request for a particular cloud service 216. To continue the previous example, such information may likewise include a user's interactions (e.g., uploading internal sales data to a cloud service 216), the date, time and frequency of such interactions, and data associated with the location of the user. Skilled practitioners of the art will recognize that many such embodiments and examples are possible. Accordingly, the foregoing is not intended to limit the spirit, scope or intent of the invention.

As likewise used herein, a protected endpoint 202 broadly refers to a policy-based approach to network security that typically requires endpoint devices 204 to comply with particular criteria when accessing network resources, such as a cloud service 216. As an example, a given endpoint device 204 may be required to have a particular operating system (OS), or version thereof, a Virtual Private Network (VPN) client, anti-virus software with current updates, and so forth. In certain embodiments, the protected endpoint 202 may be implemented to perform shadow IT discovery operations, described in greater detail herein.

In certain embodiments, the endpoint agent 206 may be implemented to universally support a variety of operating systems, such as Apple Macintosh®, Microsoft Windows®, Linux®, and so forth. In certain embodiments, the endpoint agent 206 may interact with the endpoint device 204 through the use of low-level hooks 212 at the OS level. It will be appreciated that the use of low-level hooks 212 allows the endpoint agent 206 to subscribe to multiple events through a single hook. Accordingly, multiple functionalities provided by the endpoint agent 206 can share a single data stream, using only those portions of the data stream they may individually need. Accordingly, system efficiency can be improved and operational overhead reduced.

In certain embodiments, the endpoint agent 206 may provide a common infrastructure for pluggable feature packs 208. In various embodiments, the pluggable feature packs 208 may provide certain security management functionalities. Examples of such functionalities may include various anti-virus and malware detection, data loss prevention (DLP), insider threat detection, and so forth. In certain embodiments, the security management functionalities may include one or more shadow IT discovery functionalities, described in greater detail herein. In certain embodiments, these shadow IT discovery functionalities may be provided by a shadow IT discovery feature pack 210.

In certain embodiments, a particular pluggable feature pack 208 may be invoked as needed by the endpoint agent 206 to provide a given functionality. In certain embodiments, individual features of a particular pluggable feature pack 208 may be invoked as needed. It will be appreciated that the ability to invoke individual features of a pluggable feature pack 208, without necessarily invoking all such features, will likely improve the operational efficiency of the endpoint agent 206 while simultaneously reducing operational overhead. Accordingly, the endpoint agent 206 can self-optimize in certain embodiments by using the common infrastructure and invoking only those pluggable components that are applicable or needed for a given shadow IT discovery operation.

In certain embodiments, individual features of a pluggable feature pack 208 may be invoked by the endpoint agent 206 according to the occurrence of a particular user behavior. In certain embodiments, the individual features of a pluggable feature pack 208 may be invoked by the endpoint agent 206 according to the context of a particular user behavior. As an example, the context may be the user enacting the user behavior, their associated risk classification, which resource or cloud service 216 they may be requesting, and so forth. In certain embodiments, the pluggable feature packs 208 may be sourced from various cloud security services 218. In certain embodiments, the pluggable feature packs 208 may be dynamically sourced from various cloud security services 218 by the endpoint agent 206 on an as-need basis.

In certain embodiments, the endpoint agent 206 may be implemented with a thin hypervisor 214, which can be run at Ring −1, thereby providing protection for the data endpoint agent 206 in the event of a breach. As used herein, a thin hypervisor broadly refers to a simplified, OS-dependent hypervisor implemented to increase security. As likewise used herein, Ring −1 broadly refers to approaches allowing guest operating systems to run Ring 0 (i.e., kernel) operations without affecting other guests or the host OS. Those of skill in the art will recognize that many such embodiments are possible. Accordingly, the foregoing is not intended to limit the spirit, scope or intent of the invention.

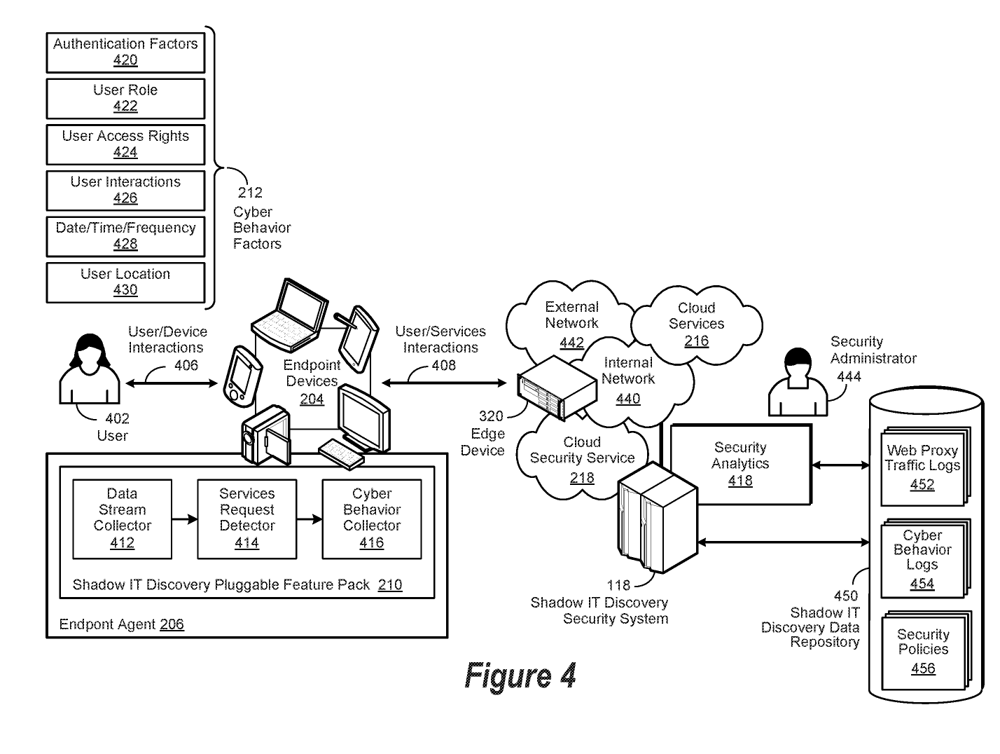

FIG. 3 is a simplified block diagram of the operation of a shadow IT discovery environment implemented in accordance with an embodiment of the invention. In certain embodiments, a shadow IT discovery system 118 may be implemented to manage risk associated with non-authorized use of a cloud service 216, as described in greater detail herein. In certain embodiments, the shadow IT discovery system 118 may be implemented on a network edge device 320. In certain embodiments, the shadow IT discovery system 118 may be implemented in combination with a web proxy 322, likewise implemented on the network edge device 320.

Skilled practitioners of the art will be familiar with proxy servers, which may be implemented as a specialized information handling system or as a software application, to act as an intermediary for requests from client devices seeking resources from other servers. In general, a client device first establishes communication with a. proxy server. Once the communication is established, the user may request a particular service, such as an application, file, connection, web page, or other resource available from a different server. In turn, the proxy server evaluates the request to determine whether it can simplify, manage or constrain its complexity. Once such evaluation is completed, the proxy server forwards the request to a target server. Those of skill in the art will likewise have an appreciation that one reason for the development of proxy servers was to add structure and encapsulation to distributed systems. Today, many proxy servers are configured as web proxies 322, which facilitate access to web-based content by providing anonymity, bypassing IP address blocking, or a combination of the two.

In certain embodiments, the network edge device 320 may be implemented in a bridge, a firewall, or a passive monitoring configuration. In certain embodiments, the edge device 320 may be implemented as software running on an information processing system. In certain embodiments, the network edge device 320 may be implemented to provide integrated logging, updating and control. In certain embodiments, the integrated logging, updating and control is used manage a repository of web proxy traffic logs 324. In certain embodiments, the edge device 320 may be implemented to receive network requests and context-sensitive user behavior information in the form of enriched cyber behavior information 326, described in greater detail herein, from an endpoint agent 206, likewise described in greater detail herein.

In certain embodiments, the shadow IT discovery 118 system may be implemented as both a source and a sink of enriched cyber behavior information 326. In certain embodiments, the shadow IT discovery 118 system may be implemented to serve requests for user/resource risk data, track the shadow IT discovery 118 system's overall health, or a combination thereof. In certain embodiments, the edge device 320 and the endpoint agent 206, individually or in combination, may provide certain cyber behavior information to the shadow IT discovery 118 system using either push or pull approaches familiar to skilled practitioners of the art.

As described in greater detail herein, the edge device 320 may be implemented in certain embodiments to receive enriched cyber behavior information 326 from the endpoint agent 206. It will be appreciated that such enriched cyber behavior information 326 will likely not be available for provision to the edge device 320 when an endpoint agent 206 is not implemented for a corresponding endpoint device 204. However, the lack of such enriched user behavior information may be accommodated in certain embodiments, albeit with reduced shadow IT discovery functionality,

In certain embodiments, a given user behavior may be enriched by an associated endpoint agent 206 attaching contextual information to an HTTP request for a particular cloud service 216. In certain embodiments, the contextual information may include the user's log-in information (e.g., UserID and password), authentication information associated with the user (e.g., private and public keys, digital certificates, etc.), their role (e.g., sales administrator), their associated access rights (e.g., sales forecasts). In certain embodiments, the contextual information may likewise include a user's interactions (e.g., uploading internal sales data to a cloud service 216), the date, time and frequency of such interactions, and data associated with the location of the user.

In certain embodiments, the contextual information may be embedded within the HTTP request, which is then provided as enriched cyber behavior information 326. In certain embodiments, the contextual information may be concatenated, or appended, to a network request, which in turn is provided as enriched cyber behavior information 326. In these embodiments, the enriched cyber behavior information 326 may be parsed upon receipt to separate the HTTP request and its associated contextual information. Those of skill in the art will recognize that one possible disadvantage of such an approach is that it may perturb certain Intrusion Detection System and/or Intrusion Detection Prevention (IDS/IDP) systems implemented on a network 140.

In certain embodiments, new flow requests may be accompanied by a contextual information packet sent to the edge device 320. In certain embodiments, the new flow requests may be provided as enriched cyber behavior information 326. In certain embodiments, the endpoint agent 206 may also send updated contextual information to the edge device 320 once it becomes available. As an example, an endpoint agent 306 may provide a list of cloud services 216 that have been accessed by a user, device or system at any point in time once the contextual information has been collected. In certain embodiments, the list of cloud services 216, and their associated HTTP requests, may be stored in a repository of web proxy traffic logs 324. In certain embodiments, point analytics processes executing on the edge device 320 may request certain cloud security services 218. As an example, risk scores on a per-user basis may be requested.

In certain embodiments, contextual information associated with a particular cyber behavior may be attached to various network service requests. In certain embodiments, the request may be wrapped and then handled by proxy. In certain embodiments, a small packet of contextual information associated with a particular cyber behavior may be sent with a service request. In certain embodiments, service requests may be related to Domain Name Service (DNS), web, email, and so forth, all of which are essentially requests for service by an endpoint device 204. Accordingly, such requests can be enriched by the addition of cyber behavior contextual information (e.g., UserAccount, interactive/automated, data-touched, etc.). As a result, the edge device 320 can then use this information to manage the appropriate response to submitted requests.

In certain embodiments, the shadow IT discovery system 118 may be implemented as a cloud security service 218. In certain embodiments, the shadow IT discovery system 118 may be implemented with an endpoint agent 206 to perform agent-based shadow IT discovery operations. In certain embodiments, the shadow IT discovery system 118 may be implemented without an endpoint agent 206 to perform agentless shadow IT discovery operations. In these embodiments, the shadow IT discovery operations, described in greater detail herein, are implemented to determine whether the use of a particular cloud service 216 is authorized or unauthorized.

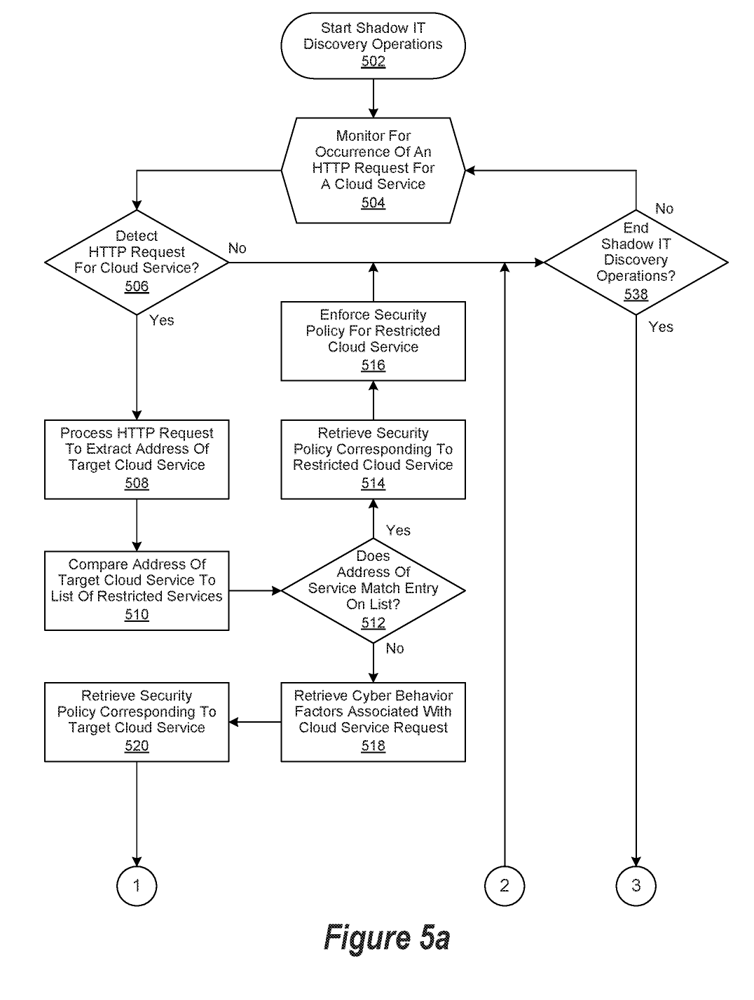

FIG. 4 is a simplified block diagram of the operation of a shadow IT discovery security environment implemented in accordance with an embodiment of the invention. In various embodiments, a shadow IT discovery security system 118 is implemented to assess the risk corresponding to the occurrence of a cloud services request. As used herein, a cloud services request broadly refers to a Hypertext Transfer Protocol (HTTP) request, familiar to those of skill in the art, containing a request for the provision of a particular cloud service 216, or associated function thereof. In certain embodiments, the shadow IT discovery system 118 may be implemented as a cloud security service 218. In certain embodiments, the shadow IT discovery 118 system may include a security analytics 412 system.

In certain embodiments, user behavior may be monitored during user/device interactions 406 between the user 402 and an endpoint device 204. In certain embodiments, as described in greater detail herein, an endpoint agent 206 is implemented in combination with the endpoint device 204 to perform the user behavior monitoring. In certain embodiments, the endpoint agent 206 may be implemented to include a shadow IT discovery pluggable feature pack 210. In certain embodiments, the shadow IT discovery pluggable feature pack 210 may be further implemented to include a data stream collector 412 module, a cloud services request detector 414 module, and a cyber behavior collector 416 module.

In certain embodiments, the data stream collector 412 module may be implemented to capture data streams resulting from user/device interactions 406 between a user 402 and a corresponding endpoint device 204. In certain embodiments, the data stream collector 412 module may likewise be implemented to capture data streams resulting from user/network interactions 408 between an endpoint device 204 and an edge device 320 implemented on an internal network 440. In certain embodiments, the cloud services request detector 414 module may be implemented to identify the occurrence of a cloud services request within the captured data streams.

In certain embodiments, the cloud services request may occur during a user/device interaction 406 with an endpoint device 204. In certain embodiments, the cloud services request may occur during a user/network interaction 408 with an edge device 202 implemented on an internal network 440. In certain embodiments, the cloud service 216 associated with a given cloud services request may be accessed via an internal network 544, an external network 546, or a combination thereof.

In certain embodiments, the cyber behavior collector 416 module may be implemented to collect various cyber behavior factors 212 associated with a particular cloud services request. In certain embodiments, the cyber behavior factors 212 may include user authentication factors 420, user role 422 information, and user access rights 424 information associated with the user 402 enacting the cloud services request operation. In certain embodiments, the cyber behavior factors 212 may likewise include individual user interactions 424 (e.g., key strokes and other user gestures, file uploads and downloads, etc.) associated with a particular cloud services request. Likewise, the cyber behavior factors 212 may include the date, time and frequency of various cloud services request operations, and the location 430 of the user 402 when a cloud services request is enacted. Skilled practitioners of the art will recognize that many such cyber behavior factors are possible. Those of skill in the art will likewise recognize that many such embodiments are possible. Accordingly, the foregoing is not intended to limit the spirit, scope or intent of the invention.

In certain embodiments, the shadow IT discovery system 118 is implemented to perform various shadow IT discovery operations, including detection of a cloud services request. In certain embodiments, the shadow IT discovery operation may be performed by a user 402, a process, a device, a system, or a combination thereof. In certain embodiments, the shadow IT discovery system 118 may be implemented to perform a shadow IT discovery scan of certain web proxy traffic logs 452 to identify various cloud services requests. In certain embodiments, the shadow IT discovery scan may include a comparison of a cloud services requests and a user's associated cyber behavior. In certain embodiments, the comparison of the cloud services requests, and the user's associated cyber behavior, may be performed by the security analytics 418 system.

In certain embodiments, shadow IT discovery operations are initiated by the performance of ongoing monitoring operations to detect the occurrence of a Hypertext Transfer Protocol (HTTP) request for a cloud service 216. Once an occurrence of an HTTP request for a cloud service 216 has been detected, then the HTTP request is processed to extract the address of the target cloud service 216. In certain embodiments, the HTTP request may be stored in a web proxy traffic log 452, which in turn may be stored in a shadow IT discovery data repository 450.

In certain embodiments, the address of the target cloud service 216 may include a Uniform Resource Locator (URL) familiar to those of skill in the art. The extracted address of the target cloud service 216 is then compared to a list of restricted cloud services 216, followed by a determination whether the extracted address matches an entry on the list of restricted cloud services 216. If so, then a security policy 456 corresponding to the restricted cloud service 216 is retrieved. In certain embodiments, the security policy 456 may be stored in the shadow IT data repository 450. Once retrieved, the corresponding security policy 456 is enforced.

As an example, the security policy 456 may state the requested cloud service 216 is not authorized for use by the user. In this example, the user's access to the cloud service 216 may be blocked. Alternatively, the user may be allowed to conditional access the requested cloud service 216, but such access is restricted to certain uses. To continue the example, the requested cloud service 216 may provide various sales automation functionalities requiring access to customer sales data, which is not allowed by the security policy 456. Accordingly, access to the cloud service 216 may be blocked if the user 402 attempts to upload a file containing such customer data to the cloud service. However, the user may simply enact a cloud services request to explore other functionalities and capabilities the cloud service 216 can provide, in which case the user 402 is allowed access.

In certain embodiments, the security policy may be enforced according to a particular traffic signature. As used herein, a traffic signature broadly refers to one or more HTTP requests containing a request to provide certain information. In various embodiments, a particular traffic signature corresponds to a generic HTTP signature. As used herein, a generic HTTP signature broadly refers to one or more HTTP requests containing a request to provide information. In certain embodiments, such HTTP requests may be originated by the user 402, the cloud service 216, or a combination thereof. As an example, a user 402 may originate an HTTP request to a particular cloud service 216 to access a login page. In response, the cloud service 216 may submit an HTTP request to the user 402 for their login credentials. In turn, the user 402 may submit an HTTP request to the cloud service 216 to accept their login credentials, and so forth. In certain embodiments, certain HTTP requests corresponding to a first traffic signature may be allowed by a security policy 456 may be allowed, while other HTTP requests corresponding to a second traffic signature may not.

In certain embodiments, the security policy may be enforced according to a particular traffic signature in accordance with certain cyber behavior. As an example, a user 402 may submit an HTTP request to a cloud service 216 to upload a file. In this example, the HTTP request to upload a file may correspond to a traffic signature typically allowed by a particular security policy 456. However, the user 402 may have enacted associated cyber behavior that involved downloading proprietary information to the file they intend to upload. To continue the example, while the security policy 456 may allow a file upload to the cloud service 216, it does not allow uploading proprietary information. In this example, it will be appreciated that the addition of certain cyber behavior to particular traffic signature will likely improve the effectiveness of the security policy 456.

However, if it was determined that the address of the target cloud service 216 does not match an entry on the list of restricted cloud services 216, then cyber behavior factors 212 associated with the HTTP request, described in greater detail herein, are retrieved. In certain embodiments, the associated cyber behavior factors 212 may be stored in a cyber behavior log 454, which in turn may be stored in the shadow IT discovery data repository 450. Thereafter, a security policy 456 corresponding to the target cloud service 216 is retrieved and then used to perform shadow IT discovery analytics operations on the HTTP request and its associated cyber behavior factors 212. In certain embodiments, the shadow IT discovery analytics operations may be performed by the security analytics system 418, a security administrator 444, or a combination thereof. If it is determined the results of the shadow IT discovery analytics operations conform to the retrieved security policy 456, then it is enforced. The method by which the security policy 456 is enforced is a matter of design choice.

However, if it was determined that the results of the shadow IT discovery analytics operations do not conform to the retrieved security policy 456, then the retrieved cyber behavior factors 212 are used to perform additional shadow IT discovery analytics. The results of the additional shadow IT discovery analytics are then used to determine risk associated with use of the target cloud service 216, followed by a determination being made whether to restrict use of the target cloud service 216. If not, then unrestricted use of the target cloud service 216 is allowed. Otherwise, use of the target cloud service 216 is restricted. The method by which it is determined whether to restrict use of the target cloud service 216, and the method by which its use is restricted, are a matter of design choice.

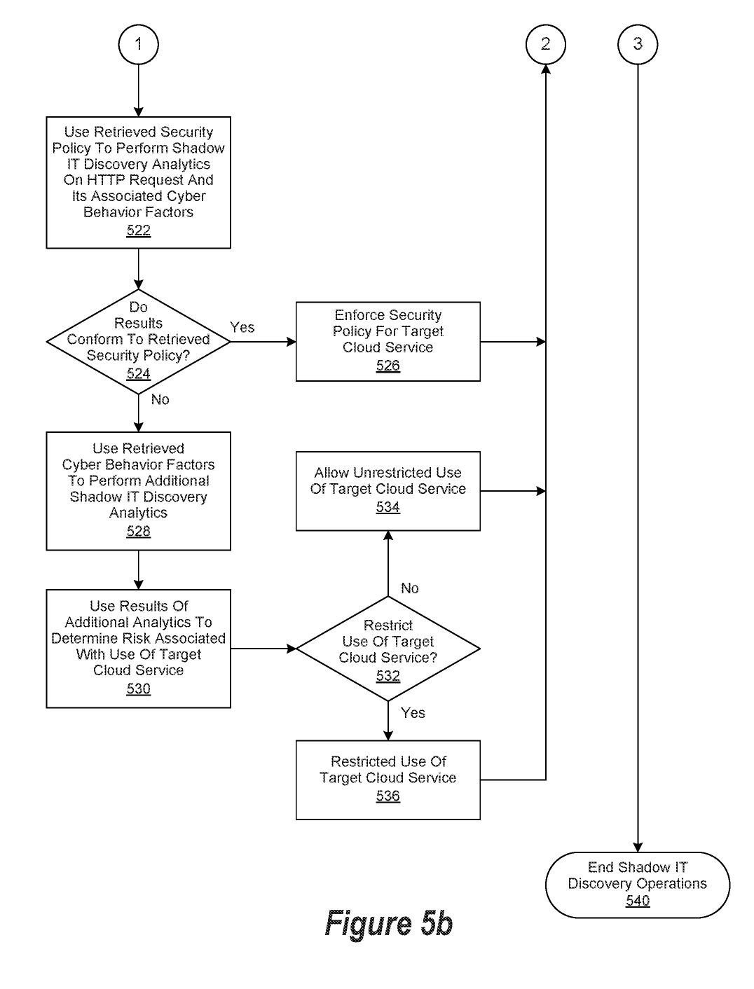

FIGS. 5a through 5b are a generalized flowchart of the performance of shadow IT discovery operations implemented in accordance with an embodiment of the invention. In this embodiment, shadow IT discovery operations are begun in step 502, followed by the performance of ongoing monitoring operations in step 504 to detect the occurrence of a Hypertext Transfer Protocol (HTTP) request for a cloud service. A determination is then made in step 506 an HTTP request for a cloud service been detected. If not, then a determination is made in step 538 whether to end shadow IT discovery operations. If not, then the process is continued, proceeding with step 604. Otherwise shadow IT discovery operations are ended in step 540.

However, if it was determined in step 506 that an occurrence of an HTTP request for a cloud service has been detected, then the HTTP request is processed in step 508 to extract the address of the target cloud service. In certain embodiments, the address of the target cloud service may include a Uniform Resource Locator (URL) familiar to those of skill in the art. The extracted address of the target cloud service is then compared to a list of restricted cloud services in step 510, followed by a determination being made in step 512 whether the extracted address matches an entry on the list of restricted cloud services. If so, then a security policy corresponding to the restricted cloud service is retrieved in step 514 and enforced in step 516. The process is then continued, proceeding with step 538.

However, if it was determined in step 512 that the address of the target cloud service does not match an entry on the list of restricted cloud services, then cyber behavior factors associated with the HTTP request, described in greater detail herein, are retrieved in step 518. Then, in step 520, a security policy corresponding to the target cloud service is retrieved, followed by its use in step 522 to perform shadow IT discovery analytics operations on the HTTP request and its associated cyber behavior factors. A determination is then made in step 524 whether the results of the shadow IT discovery analytics operations conform to the retrieved security policy. If so, then the security policy is enforced in step 526 and the process if continued, proceeding with step 538.

However, if it was determined in step 524 that the results of shadow IT discovery analytics operations do not conform to the retrieved security policy, then the retrieved cyber behavior factors are used in step 528 to perform additional shadow IT discovery analytics. The results of the additional shadow IT discovery analytics are then used in step 530 to determine risk associated with use of the target cloud service, followed by a determination being made in step 532 to restrict use of the target cloud service. If not, then unrestricted use of the target cloud service is allowed in step 534 and the process is continued, proceeding with step 538. Otherwise, use of the target cloud service is restricted in step 536 and the process is continued, proceeding with step 538.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable od for performing a shadow information technology discover operation, comprising:
monitoring interactions initiated via an endpoint device;
determining when the interactions comprise a cloud services request, the cloud services request comprising a request by a user to access a cloud service;
monitoring interactions between the user and the cloud service when a request to access the cloud service is detected;
determining whether the interactions between the user and the cloud service represent a non-authorized use of the cloud service;
managing risk associated with non-authorized use of the cloud service.

2. The method of claim 1, wherein:
the managing risk comprises elevating a risk level associated with the user when the interactions represent the non-authorized use of the cloud service.

3. The method of claim 1, wherein:
the interactions between the user and the cloud service are monitored via a shadow information technology discovery system.

4. The method of claim 1, wherein:
the monitoring includes review of web proxy traffic logs.

5. The method of claim further comprising:
determining whether the cloud service corresponds to a restricted cloud service; and,
when the cloud service corresponds to the restricted cloud service then a security policy corresponding to the restricted cloud service is enforced.

6. The method of claim 1, wherein:
managing risk associated with the non-authorized use of the cloud service includes restricting use of the cloud service.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
monitoring interactions initiated via an endpoint device;
determining when the interactions comprise a cloud services request, the cloud services request comprising a request by a user to access a cloud service;
monitoring interactions between the user and the cloud service when a request to access the cloud service is detected;
determining whether the interactions between the user and the cloud service represent a non-authorized use of the cloud service;
managing risk associated with non-authorized use of the cloud service.

8. The system of claim 7, wherein:
the managing risk comprises elevating a risk level associated with the user when the interactions represent the non-authorized use of the cloud service.

9. The system of claim 7, wherein:
the interactions between the user and the cloud service are monitored via a shadow information technology discovery system.

10. The system of claim 7, wherein:
the monitoring includes review of web proxy traffic logs.

11. The system of claim 7, wherein the instructions executable by the processor are further configured for:
determining whether the cloud service corresponds to a restricted cloud service; and,
when the cloud service corresponds to the restricted cloud service then a security policy corresponding to the restricted cloud service is enforced.

12. The system of claim 7, wherein:
managing risk associated with the non-authorized use of the cloud service includes restricting use of the cloud service.

3. A non-transitory, computer-readable storage medium embodying computer program code, the computer program code comprising computer executable instructions configured for:
monitoring interactions initiated via an endpoint device;
determining when the interactions comprise a cloud services request, the cloud services request comprising a request by a user to access a cloud service;
monitoring interactions between the user and the cloud service when a request to access the cloud service is detected;
determining whether the interactions between the user and the cloud service represent a non-authorized use of the cloud service;
managing risk associated with non-authorized use of the cloud service.

14. The non-transitory, computer-readable storage medium of claim 13, wherein:
the managing risk comprises elevating a risk level associated with the user when the interactions represent the non-authorized use of the cloud service.

15. The non-transitory, computer-readable storage medium of claim 13, wherein:
the interactions between the user and the cloud service are monitored via a shadow information technology discovery system.

16. The non-transitory, computer-readable storage medium of claim 13, wherein:
the monitoring includes review of web proxy traffic logs.

17. The non-transitory, computer-readable storage medium of claim 13, wherein the computer executable instructions are further configured for:
determining whether the cloud service corresponds to a restricted cloud service; and,
when the cloud service corresponds to the restricted cloud service then a security policy corresponding to the restricted cloud service is enforced.

18. The non-transitory, computer-readable storage medium of claim 13, wherein:
managing risk associated with the non-authorized use of the cloud service includes restricting use of the cloud service.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
